(19) United States
(12) Patent Application Publication
(10) Pub. No.: US 2014/0207613 A1
(43) Pub. Date: Jul. 24, 2014

(54) SYSTEM AND METHOD FOR REPUTATION-BUILDING VOLUNTARY DIGITAL COMMERCE

(71) Applicant: Laudd, Inc., Cupertino, CA (US)

(72) Inventor: Atul Tulshibagwale, Cupertino, CA (US)

(73) Assignee: Laudd, Inc., Cupertino, CA (US)

(21) Appl. No.: 14/083,278

(22) Filed: Nov. 18, 2013

Related U.S. Application Data
(60) Provisional application No. 61/755,579, filed on Jan. 23, 2013.

(51) Int. Cl. G06Q 30/06

(52) U.S. Cl. CPC G06Q 30/0609; G06Q 30/0613
USPC 705/26.35

(57) ABSTRACT

Described herein are methods and apparatus for providing a reputation-building voluntary digital commerce system. Under this system, a new type of payment referred to herein as a “Compelled Payment” is a voluntary digital payment that contributes to building the consumer's reputation (the “C-Rep”). The C-Rep is, in certain embodiments, a quantity which has one or more attributes that provide a measure of the consumer's stature, in absolute terms or in comparison with others. In a compelled payment system, the consumer's C-Rep may determines significant aspects of the consumer's digital experience such as the speed, variety, currency (i.e. how recent), quality and quantity of digital content, goods or services (i.e. the wares) the consumer is offered or is able to access anywhere in the consumer's digital experience with C-Merchants.

### RELATED APPLICATIONS

The present application claims priority to U.S. Provisional Application No. 61/755,579 entitled “System and Method for Reputation-Building Voluntary Digital Commerce” and filed Jan. 23, 2013, the contents of which are hereby incorporated by reference in its entirety.

### BACKGROUND

Digital commerce systems fall into two broad categories—required payment systems and voluntary payment systems. Required payment systems typically require the consumer to make a payment to directly facilitate a benefit to the payer such as receiving goods or services. On the other hand, voluntary payment systems typically allow consumers to make a payment that is not directly related to getting a benefit such as goods or services. Often there is no direct correlation between the benefit the consumer gets and the payment he has made, though there may be a correlation between the benefit the consumer gets and the collective payments made by a group of consumers.

### SUMMARY

Described herein are methods and apparatus for providing a reputation-building voluntary digital commerce system. Under this system, a new type of payment referred to herein as a “Compelled Payment” is described.

In certain embodiments, a compelled payment is a voluntary digital payment that contributes to building the consumer's reputation (the “C-Rep”). The C-Rep is, in certain embodiments, a quantity which has one or more attributes that provide a measure of the consumer's stature, in absolute terms or in comparison with others.

In a compelled payment system, the consumer's C-Rep, in certain embodiments, determines significant aspects of the consumer's digital experience such as the speed, variety, currency (i.e. how recent), quality and quantity of digital content, goods or services (i.e. the wares) the consumer is offered or is able to access anywhere in the consumer's digital experience with C-Merchants. The C-Rep may be used by non C-Merchants also to determine similar aspects of the consumer's interaction with them.

In certain embodiments, the disclosed technology is directed to a method includes: (a) receiving, from a consumer, via a network, a request for information regarding wares available from a merchant; (b) identifying, by a processor of a computing device, from the request, a consumer identification; (c) obtaining, from a compelled payment broker, a consumer reputation score associated with the consumer identification, wherein the consumer reputation score is based in part upon one or more payments made by the consumer in relation to one or more prior wares provided to the consumer by one or more merchants; (d) identifying, by the processor, one or more wares; (e) providing, to the consumer at a second computing device, information regarding the one or more wares; and (f) at least one of (i) identifying the one or more wares and (ii) providing information regarding the one or more wares is based in part upon the consumer reputation score.

In certain embodiments, the method of providing information regarding the one or more wares further includes: (a) providing, for review by the consumer at the second computing device, an offer to convey one or more wares to the consumer; (b) receiving, from the consumer at the second computing device, a request to convey one or more wares to the consumer; and (c) providing, to the consumer at the second computing device, one or more wares.

In certain embodiments, the method of providing information regarding the one or more wares further includes providing, to the consumer at the second computing device, one or more wares.

In certain embodiments, each ware of the one or more wares is associated with one or more aspects, wherein the one or more aspects comprise at least one of a currency and a quality; and identifying the one or more wares includes: (a) identifying at least one of a currency level and a quality level associated with the consumer reputation score; and (b) selecting each ware of the one or more wares based in part upon at least one of the currency and the quality.

In certain embodiments, identifying the one or more wares includes selecting a total number of the one or more wares based at least in part upon the consumer reputation score.

In certain embodiments, providing information regarding the one or more wares includes: (a) identifying a service level associated with the consumer reputation score; and (b) transmitting the information regarding the one or more wares at a speed relative to the service level.

In certain embodiments, providing information regarding the one or more wares includes identifying at least one of a graphical layout and an advertisement strategy based upon the consumer reputation score.

In certain embodiments, the method further includes receiving, responsive to the request for payment, remittance associated with the one or more wares, and updating, via the compelled payment broker, the consumer reputation score.

In certain embodiments, the consumer reputation score is based in part upon a frequency of payment relative to a number of times the merchant provides one or more wares to the consumer.

In certain embodiments, the consumer reputation score is based in part upon a difference between a requested payment value and an actual payment value and the consumer reputation score is based in part upon one or more other wares conveyed by one or more other merchants.

In certain embodiments, the method further includes prior to receiving remittance, providing, to the consumer, a reminder regarding the request for payment, and the consumer reputation score is based in part upon at least one of an expedience of payment and a number of reminders issued prior to payment.

In certain embodiments, the method further includes prior to providing the request for payment: (a) receiving, from the consumer, a request for at least one ware of the one or more wares; and (b) providing, to the consumer, the at least one ware.

The disclosed technology, in certain embodiments, includes a system includes: (a) a processor; and (b) a memory having instructions stored thereon, wherein the instructions, when executed, cause the processor to: (i) receive, from a consumer, via a network, a request for information regarding wares available from a merchant; (ii) identify, from the request, a consumer identification; (iii) obtain, from a compelled payment broker, a consumer reputation score associated with the consumer identification, wherein the consumer reputation score is based in part upon one or more payments made by the consumer in relation to one or more prior wares provided to the consumer by the merchant; (iv) identify one or more wares; (v) provide, to the consumer at a second computing device, information regarding the one or more wares; and wherein at least one of identifying the one or more wares and providing information regarding the one or more wares is based in part upon the consumer reputation score.

In certain embodiments, providing information regarding the one or more wares further includes: (a) providing, for review by the consumer at the second computing device, an offer to convey one or more wares to the consumer; (b) receiving, from the consumer at the second computing device, a request to convey one or more wares to the consumer; and (c) providing, to the consumer at the second computing device, one or more wares.

In certain embodiments, providing information regarding the one or more wares further includes providing, to the consumer at the second computing device, one or more wares.

In certain embodiments, obtaining the consumer reputation score includes providing, to the compelled payment broker, context information regarding the request for information.

In certain embodiments, providing information regarding the one or more wares comprises embedding, within the information regarding the one or more wares, a tracking item associated with the compelled payment broker.

In certain embodiments, the tracking item comprises a cookie. In certain embodiments, the tracking item is invisible to the consumer upon reviewing the information regarding the one or more wares.

In certain embodiments, the disclosed technology includes a non-transitory computer readable medium having instructions stored thereon, wherein the instructions, when executed by a processor, cause the processor to: (a) receive, from a consumer, via a network, a request for information regarding wares available from a merchant; (b) identify, from the request, a consumer identification; (c) obtain, from a compelled payment broker, a consumer reputation score associated with the consumer identification, wherein the consumer reputation score is based in part upon one or more payments made by the consumer in relation to one or more prior wares provided to the consumer by the merchant; (d) identify one or more wares; (e) provide, for review by the consumer at a second computing device, information regarding the one or more wares; and (f) provide, for review by the consumer at the second computing device, information regarding a request for payment associated at least one ware of the one or more wares; wherein at least one of a) identifying the one or more wares and b) providing information regarding the one or more wares is based in part upon the consumer reputation score.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 is an illustration of a flow chart describing a method of providing, by a C-Merchant, wares to a consumer based on the consumer's C-Rep;

FIG. 2 is an illustration of a flow chart describing a method of providing, by a compelled payment broker (CPB), a consumer's C-Rep to a C-Merchant;

FIG. 3 is an illustration of a method of interaction between a consumer, a C-Merchant, and a CPB;

FIG. 4 is an illustration of an example diagram of a page displayed when a consumer is offered wares and/or previews wares;

FIG. 5 is illustration of an example diagram of a page displayed when a consumer views a conveyed ware;

FIG. 6 is an illustration of an example diagram of a page displayed when a consumer selects to “Give-M” to a C-Merchant;

FIG. 7 is an illustration of an example diagram of when a CPB makes a XML Web-Service call to the C-Merchant that indicates the amount paid by the consumer;

FIG. 8 shows a block diagram of an exemplary cloud computing environment;

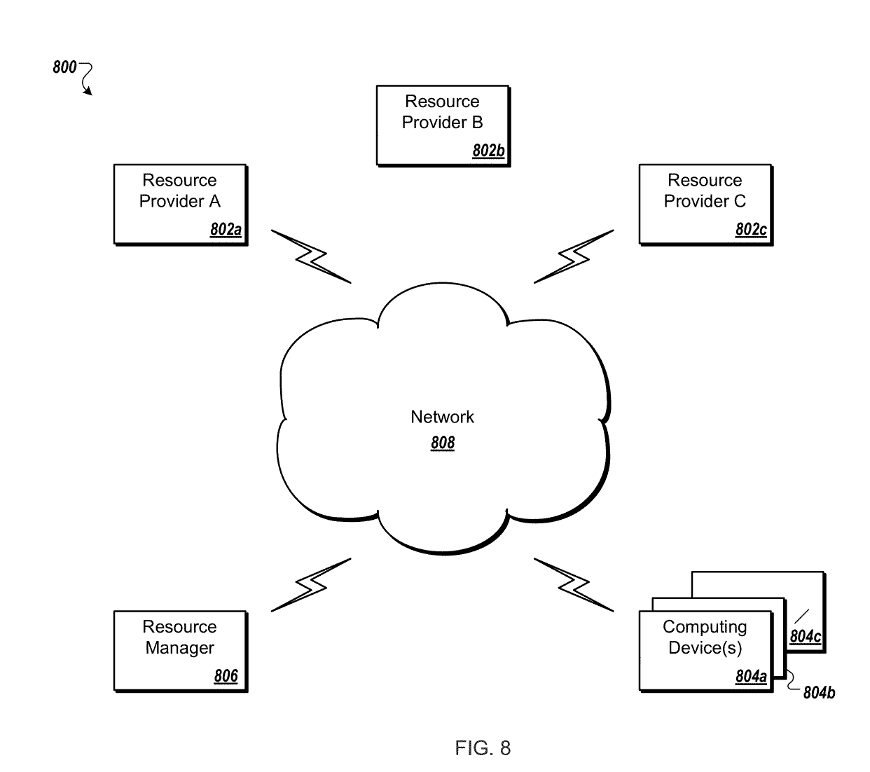

FIG. 9 is a block diagram of a computing device and a mobile computing device.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The term “ware”, as used herein, refers to an instance of physical or digital goods or content of any type, or an instance of any physical or digital service.

The term “conveyance”, as used herein, refers to an act through which a corporate or individual entity enables a consumer to order, consume, get access to or get into his possession one or more of the entity's offered wares. The conveyance may be a one-time conveyance or a regularly timed conveyance such that such wares are periodically or continuously conveyed to the consumer over a period of time.

The term “merchant”, as used herein, refers to an entity which conveys one or more of its wares as a direct result of getting a required payment, or getting a legally binding promise of a required payment from consumers. The merchant typically pre-negotiates with the consumer or pre-specifies how much the consumer must pay or be legally bound to pay in order to be conveyed the ware(s).

The “C-Rep” is, in certain embodiments, a quantity which has one or more attributes that provide a measure of the consumer's stature, in absolute terms or in comparison with others.

The term “C-Relying Party” (CRP), as used herein, refers to an entity that wants to use a consumer's C-Rep to determine aspects of the consumer's experience in its interaction with the consumer. The term C-Merchant is used to describe a part involved in a reputation-building voluntary payment system, however, the C-Merchant may instead be a party who relies on the C-Rep but does not allow consumers to make compelled payments (e.g. a C-Relying party).

The term “C-Merchant”, as used herein, refers to a corporate or individual entity that receives compelled payments. In some implementations, a C-Merchant offers the consumer the ability to make a compelled payment after the C-Merchant conveys one or more of its wares to the consumer. The C-Merchant may or may not require the consumer to make a payment before he is conveyed the wares, and the C-Merchant may or may not suggest the amount of compelled payment the consumer should make after he receives the ware. The consumer may make the compelled payment immediately after he is conveyed the wares or any time thereafter, possibly after receiving one or more reminders about the conveyance.

The disclosed technology provides a reputation-building voluntary digital commerce system. In some implementations, a compelled payment is a voluntary digital payment that contributes to building the consumer's reputation (the “C-Rep”).

In some implementations, a compelled payments system includes a central entity termed as the “Compelled Payment Broker” or CPB. In some implementations, the CPB sets up relationships with C-Merchants who wish to receive compelled payments for their wares. The CPB may require C-Merchants to provide sufficient information to enable it to transfer all or a part of any compelled payment received from consumers to the C-Merchants' possession. In some implementations, the CPB sets up prior relationships with C-Merchants to present the C-Rep information of a consumer when requested by the C-Merchant. In some implementations, the CPB tracks digital activity, including but not limited to conveyance and compelled payments of consumers who visit a C-Merchant. In some implementations, for consumers who actually make at least one compelled payment, the CPB establishes a relationship with the consumer in order to be able to debit money from the consumer's possession.

In some implementations, a C-Merchant conveys one or more of his wares to the consumer without requiring the consumer to make a payment, whether suggested, pre-negotiated, pre-specified or otherwise. Immediately after the C-Merchant conveys or begins to convey to the consumer one or more of his wares, and/or subsequently at any time after such initiation of the conveyance (e.g. while the consumer is still on the web-page which has conveyed the ware, or when the Consumer visits the C-Merchant again, or by sending email reminders to the Consumer), the C-Merchant may offer the consumer the option to make a compelled payment. The C-Merchant may or may not suggest the amount of the compelled payment the consumer should make. The consumer is not forced to make a payment either in the suggested amount or otherwise.

In some implementations, if and when the consumer decides to make a compelled payment, the consumer instructs the CPB to make a compelled payment in a specific amount to a specific C-Merchant (in most cases, the C-Merchant who has just conveyed one or more wares to the consumer, or the C-Merchant from whom the consumer has received a reminder). In some implementations, the CPB receives the instructions from the consumer to make the compelled payment to the C-Merchant. The CPB credits all or part of that payment to the C-Merchant.

In some implementations, the CPB keeps track of all consumer activity related to compelled payments made by a consumer when any of the following events occur (termed as “C-Events”): (a) the consumer is offered to be conveyed one or more wares by a C-Merchant, (b) the consumer is conveyed one or more wares by a C-Merchant (e.g. the C-Merchant informs the CPB of the quantity and detail of the ware or wares conveyed), (c) the consumer is offered to make a compelled payment immediately after the conveyance, (d) the consumer is reminded to make a compelled payment in relation to a prior conveyance, and/or (e) the consumer makes a compelled payment in reference to a specific ware that he has been conveyed by a C-Merchant (the consumer informs the CPB of the ware for which the compelled payment is being made).

In some implementations, the CPB keeps track of C-Events, and uses this information to build the consumer's C-Rep. In some implementations, the C-Rep is computed (either beforehand or upon request) through a combination of one or more parameters. The parameters used to compute the Consumer's C-Rep may include but may not be limited to: (a) the absolute amount the consumer paid for one or more wares of a particular C-Merchant, (b) the relative amount the consumer paid for a ware compared to other C-Payers, (c) the relative amount the consumer paid for a ware to the required payment for the ware at any Merchant, (d) the number of times the consumer makes a compelled payment in comparison with the number of times he is conveyed a particular type of ware by a C-Merchant (the “C-Frequency”), (e) the total value of the compelled payments made by the consumer either in aggregate of all C-Merchants or for a specific C-Merchant, or for a category of C-Merchants, (f) the average value of the compelled payments made by the consumer at any C-Merchant or a specific C-Merchant or a category of C-Merchants, (g) the length of time the consumer has been making compelled payments for any C-Merchant or a specific C-Merchant or a category of C-Merchants, (h) the average amount the consumer has paid for similar Wares to the context under which the C-Merchant is requesting the C-Rep, (i) the average amount of compelled payment the consumer has made in similar contexts as the requester's context, (j) the number of times the consumer had to be reminded before he made a compelled payment after he was conveyed a ware, and/or (k) the number of compelled payments a consumer made for similar wares after receiving subsequent reminders.

A C-Merchant may determine any parameter that affects the consumer's digital experience based on one or more parameters of the C-Rep. The parameters that affect the consumer's digital experience when interacting with the C-Merchant include, but are not limited to: (a) response speed to requests made by the consumer, (b) quality of content, layout, fonts, images, etc. that the consumer sees, (c) presence, number and intrusiveness of advertisements the consumer sees, (d) the selection of wares from the C-Merchant's inventory that is offered to the consumer, (e) quality and reliability of wares offered to the consumer, and/or (f) currency (time based) of the wares offered to the consumer.

An example of an implementation of a compelled payment system is provided below, however, other implementations are contemplated by the disclosed technology. Throughout the description, where apparatus and systems are described as having, including, or comprising specific components, or where processes and methods are described as having, including, or comprising specific steps, it is contemplated that, additionally, there are apparatus, and systems of the present invention that consist essentially of, or consist of, the recited components, and that there are processes and methods according to the present invention that consist essentially of, or consist of, the recited processing steps.

It should be understood that the order of steps or order for performing certain action is immaterial so long as the invention remains operable. Moreover, two or more steps or actions may be conducted simultaneously.

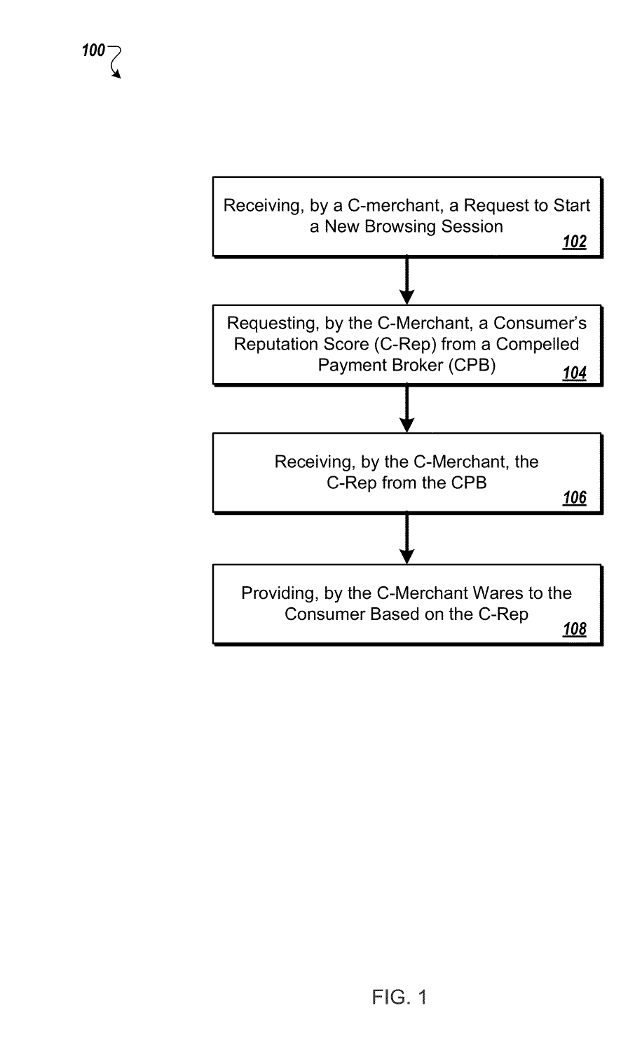

FIG. 1 illustrates a flow chart describing a method 100 of providing, by a C-Merchant, wares to a consumer based on the consumer's C-Rep.

In some implementations, the C-Rep has one or more parameters and the value of the parameters may depend upon the context in which the C-Rep is requested and depends upon historical reputation of the consumer. When a consumer visits a C-Merchant website (102), the C-Merchant may request the consumer's C-Rep from the CPB (104). When requesting C-Rep, the C-Merchant may or may not provide context information regarding the Consumer's activity, such as the page he is visiting or the ware he is about to browse or offered to be Conveyed. In some implementations, the C-Merchant receives the consumer's C-Rep (106) and provides wares to the consumer based on the consumer's C-Rep (108). Providing wares to the consumer may include providing an offer to the consumer to receive wares. The consumer may request to receive the wares by accepting the offer. In response to the acceptance, the C-Merchant may provide the wares to the consumer. In some implementations, providing wares to the consumer (108) may include conveying the wares to the consumer. In some implementations, the consumer's C-Rep impacts how the consumer is treated across all sites participating in the voluntary payment system.

In some implementations, a C-Merchant website initially sets up an account with the CPB where it specifies certain information including but not limited to: (a) its website address, (b) an address where XML Web Services calls may be made, including posting C-Rep information, and/or (c) optionally any context information specifying unique “context-ids” for each such information. In some implementations, this account information is used in responding to multiple subsequent requests from the C-Merchant website to obtain C-Rep information.

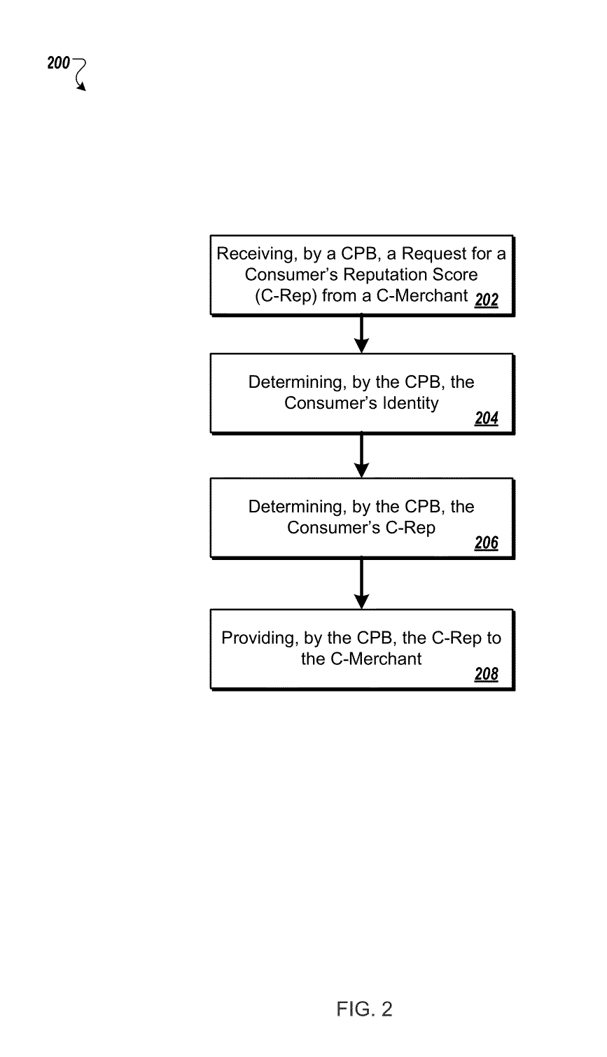

FIG. 2 illustrates a flow chart describing a method 200 of providing, by a CPB, a C-Rep to a C-Merchant. A C-Merchant may send a request to the CPB for a consumer's reputation score (202). In some implementations, the CPB determines the consumer's identity (204). The CPB may use information provided by the CPB to determine the consumer's identity. The CPB may also use information from previous transactions to determine the identity of the consumer. In some implementations, the CPB determines the consumer's C-Rep (206). The CPB may provide the C-Rep to the C-Merchant (208).

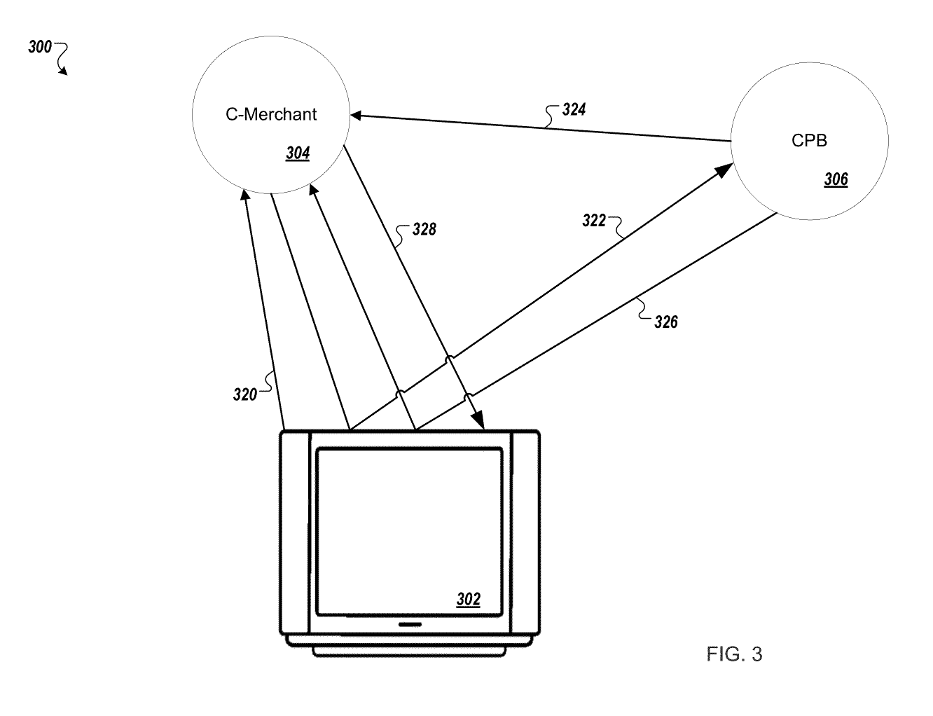

FIG. 3 is an illustration of a method 300 of interaction between a consumer, a C-Merchant, and a CPB. As shown in FIG. 3, when a user opens a new browser session with a C-Merchant (320) via a browser 302, the C-Merchant 304 first redirects (322) the user to the CPB 306 by causing the browser to request a specific URL at the CPB 306. The C-Merchant 304 may provide some contextual information and request identification information in the request to the CPB 306. The CPB 306 receives any cookies it might have set before and identifies the user. In some implementations, when the C-Merchant redirects the user to the CPB, the browser posts any previously set persistent or session cookies to the CPB. The CPB may identify the user by any one of: (a) reading a cookie presented by the browser; (b) if cookies are not present or insufficient to identify the user, from the contextual information provided to it by the C-Merchant, which may include user-identifying information; and/or (c) if contextual information is not present, but if the C-Merchant has been so setup, by conducting a federated identity exchange with the C-Merchant such that the CPB can leverage the C-Merchant's identification of the user. Examples of federated identity systems that may be used are “OAuth” or “SAML 2.0”.

If user-identifying information is not present in the C-Merchant's context and the C-Merchant cannot identify the user through the federated identity exchange, challenging the user to enter a username and a password or using other methods of challenging the user to securely identify himself, OR allowing the user to continue anonymously if the C-Merchant policy allows it.

In some implementations, the CPB 306 makes an XML Web Services call to the C-Merchant 304 and provides (324) the C-Rep along with any identifying from the C-Merchant 304 request to the C-Merchant 304. The CPB 306 then redirects (326) the user to the C-Merchant 304 by causing the browser 302 to request a “Return URL”. The Return URL may be obtained from any of: (a) the C-Merchant's 304 response to the XML Web Service call made by the CPB 306 to the C-Merchant 304, (b) the initial request made by C-Merchant 304 to the CPB 306 when the user was first redirected, and/or (c) a default URL that the C-Merchant 304 may have setup previously with the CPB 306. In some implementations, based on the consumer's C-Rep, the C-Merchant 304 displays (328) one or more wares to the consumer via the browser 302.

In some implementations, the CPB tracks users for recording C-Events. The following online activity may be tracked: (a) in order to accurately compute the C-Rep, the CPB needs to be informed of the conveyance of any ware to a consumer, and the CPB can deduce this by knowing that the user is visiting certain web pages, (b) the CPB can gain additional information that impacts C-Rep by knowing which items the consumer has previewed before choosing to view an item (selectivity in this regard shows a user's sensitivity to making compelled payments when being conveyed a ware), and/or (c) when a consumer is served a reminder (e.g. when visiting the C-Merchant website, when reminded by e-mail or otherwise).

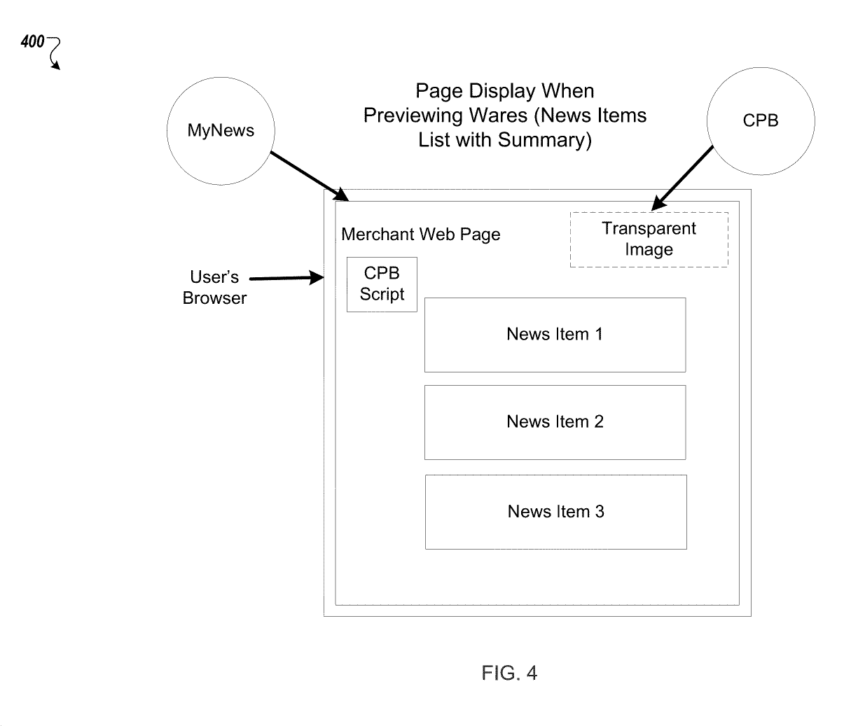

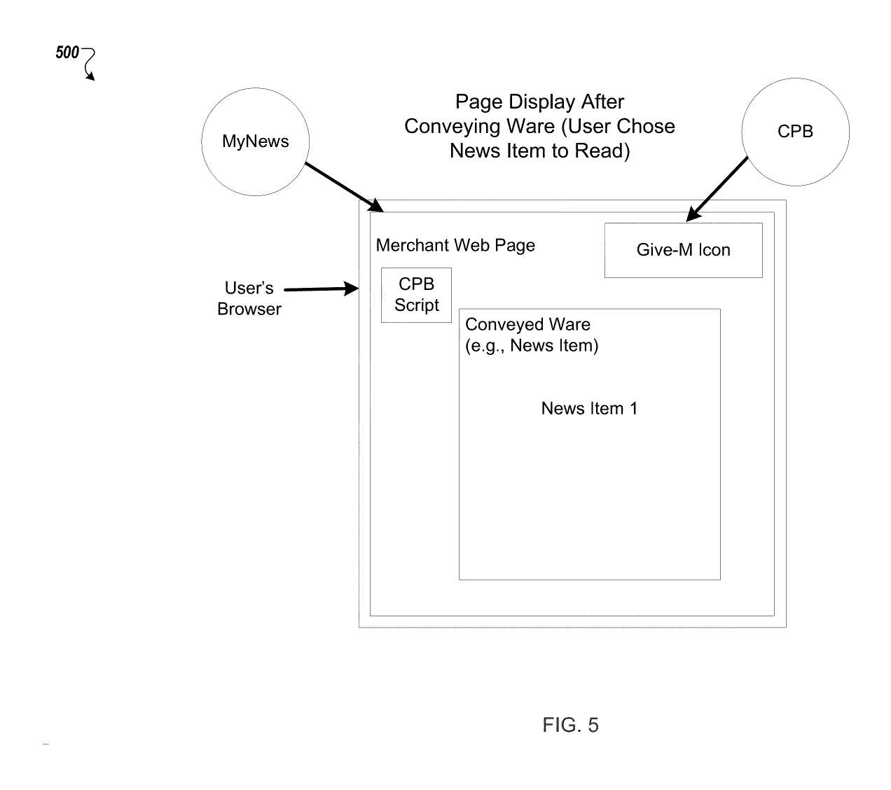

FIG. 4 is an example diagram 400 of a page displayed when a consumer is offered wares and/or previews wares (e.g. news items in a list on a CPR webpage). In some implementations, the user may navigate to multiple pages on the C-Merchant website via a browser. On each page that the C-Merchant that previews or conveys a ware, the C-Merchant embeds a tracking item by including a script that prepares the page for use with the CPB and any one or both of: (a) an invisible or hidden CPB-originated item that is requested from the page being viewed by the user (this can be done by invoking specific methods in the script or by referring to a URL from the CPB website), and (b) a visible CPB-originated “Give-M” icon as seen in FIG. 5 (Give-M is a placeholder for a name or graphic that the user recognizes to be a way of making a Compelled Payment). The “Give-M” icon may be displayed as a result of invoking a method from the script or by referring to a URL from the CPB website.

In some implementations, the presence of the CPB originated item on the page enables the CPB to understand that the specific user (who is tracked using a persistent or session cookie) has visited the particular page. Displaying the invisible CPB item indicates the user is being presented or is previewing a specific ware or wares. Information pertaining to the wares being presented or previewed may be included as a parameter to the URL which is used to request the invisible CPB item to be displayed. In some implementations, displaying the visible Give-M icon indicates that the user has been conveyed a specific ware either on the same web-page or previously by the C-Merchant. The C-Merchant includes information about the specific ware when requesting the URL that displays the Give-M icon.

In some implementations, if a compelled payment reminder is sent to the consumer by email, the CPB is either proactively notified by the C-Merchant of having sent such email or the CPB itself provides such capability that the C-Merchant uses to send reminder emails.

FIG. 5 is an example diagram 500 of a page displayed when a consumer views a conveyed ware. In some implementations, selecting the “Give-M” button starts the user's direct interaction with the CPB. In some implementations, the CPB temporarily disables the page, and displays a web dialog box that enables the user to make a payment.

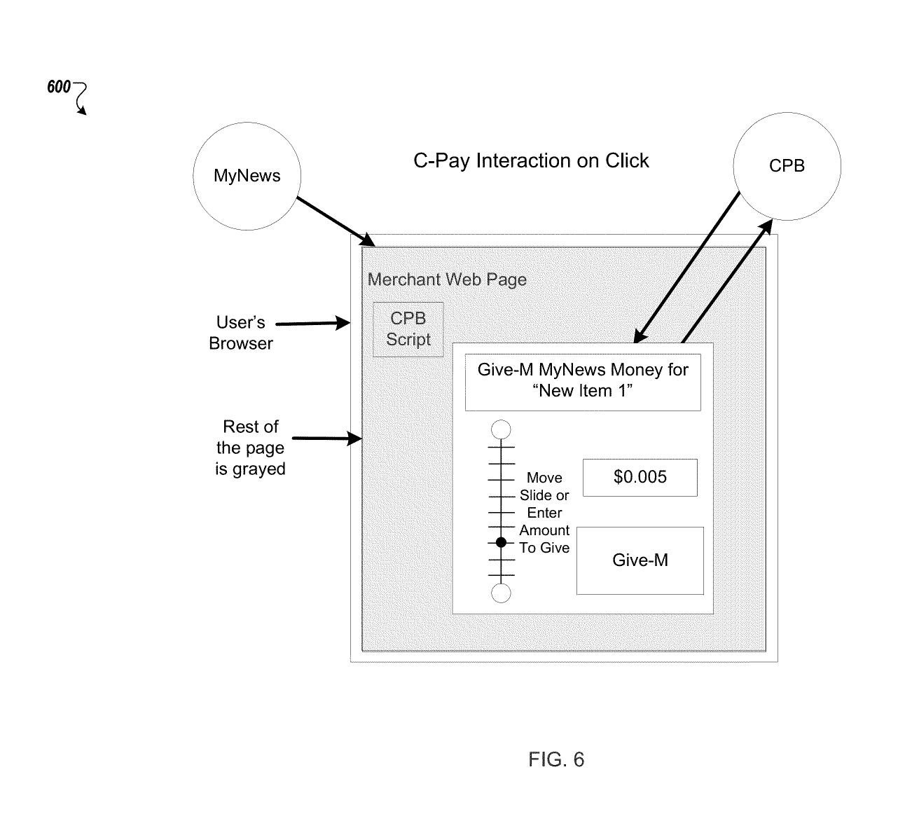

FIG. 6 is an example diagram 600 of a page displayed when a consumer selects to “Give-M” to a C-Merchant. In some implementations, the user chooses the amount of compelled payment to make, and presses the “Give-M” button. This interaction assumes that the user has already been setup in the CPB system such that the requested amount can be debited from the user's possession. Once the CPB receives the compelled payment it notifies the C-Merchant about the payment.

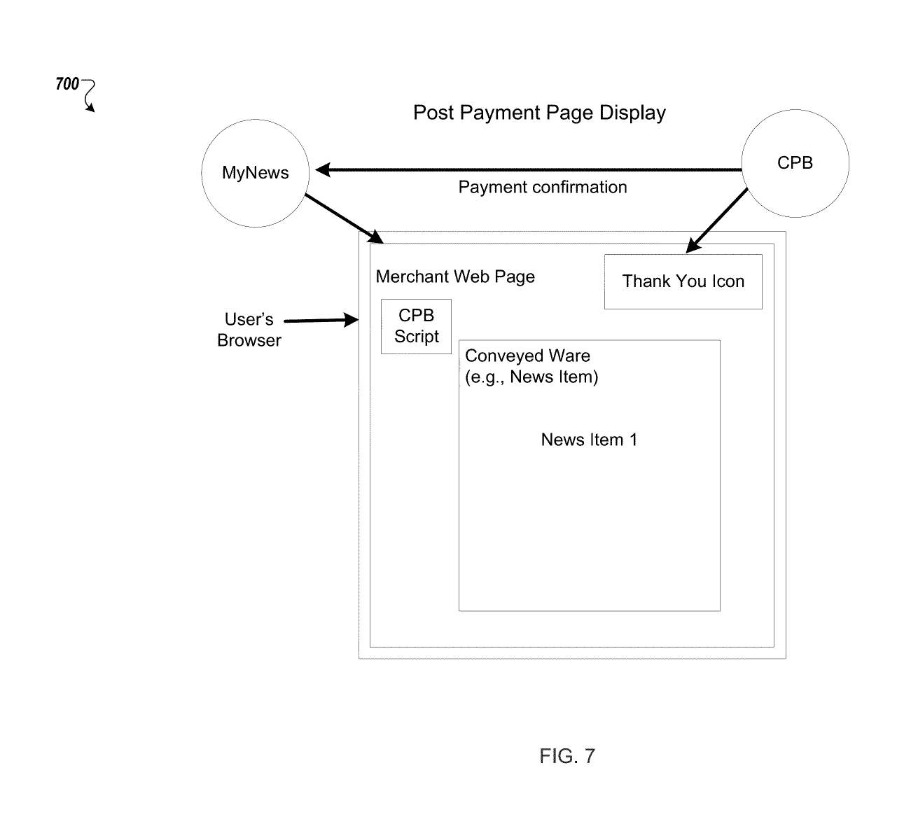

FIG. 7 is an illustration of an example diagram 700 of when a CPB makes a XML Web-Service call to the C-Merchant that indicates the amount paid by the consumer. As shown in FIG. 7, in some implementations, the CPB makes a XML Web-Service call to the C-Merchant that indicates the amount paid by the consumer. The C-Merchant may indicate in its response, its level of satisfaction with the payment. Based on this response, the CPB displays a “Thank You” icon on the page, replacing the visible “Give-M” button.

In some implementations, a news website presents news items to consumers who visit its website. The tracking item that is served by the CPB on the news website may be a small icon (termed a “C-Pay” icon) at the top or bottom of a news item similar to a “like” or “tweet” icon found on such websites. When a consumer reads the news item, the consumer can click the C-Pay icon to make a compelled payment in a standard amount (say $0.001) or click and hold the C-Pay icon to make additional payments. When the consumer makes the compelled payment, the CPB deducts the amount from the consumer's account and credits an amount to the news website's account.

In some implementations, if a consumer with a high C-Rep visits the website, the website quickly presents him with the latest content that has a much better appearance (i.e.

layout, fonts, colors, etc. are better and the page has fewer or no advertisements). In some implementations, if a consumer with a lower C-Rep visits the website, the website presents him with older content that may not have great appeal, and may be slow to respond to his requests of viewing pages.

In some implementations, when a consumer with a good C-Rep visits a music website, it quickly presents to him a web-page that has the latest music in the genres that he has previously shown interest in. In some implementations, if a consumer without a good C-Rep visits the music website, the site may be slow to load, and display older music and display advertisements on the page.

In some implementations, the website previews a variety of tracks from multiple artists and/or productions for the consumer to listen online, download or copy. The page that previews the music items may have the transparent tracking icon in it. Once the consumer chooses a track to listen to, download or copy, the consumer may navigate to a web-page that shows the “Give-M” icon. The consumer can choose to pay for the music while he downloads/listens to it or any time when he is on the page that is delivering the music to him.

In some implementations, a video website presents to consumers a selection of videos from multiple producers. When a consumer visits the website, the selection of videos he is able to view, the resolution and the speed with which he sees them may depend upon his C-Rep. After the consumer sees a video or periodically while seeing the video, the consumer may be asked to make a compelled payment, by showing a “Give-M” icon to the consumer alongside, overlapping with, interrupting the video or after the video.

In some implementations, the CPB has settings that allow consumers to optionally reveal their C-Rep when they enter a physical store. In some implementations, the consumer's identity is associated with his mobile device. When the Consumer carries this device to a store, the network infrastructure in the store (such as a Bluetooth access point or a Wi-Fi hotspot) may connect with the mobile device, with or without the consumer's explicit consent. In some implementations, the store's network infrastructure requests the consumer's mobile device to reveal its identity, after providing some identifying information about the store to the device. This store identification information may include the name of the store, the location, certain policies it adheres to (such as a privacy policy about the reputation system). Based on this information the consumer's mobile device may either automatically send the consumer's identifying information to the store's network, or prompt the consumer about revealing this information, or deny the request. This identifying information may include the consumer's picture so that he may be physically identified by the store's staff, or some other physical attribute that can unambiguously locate the consumer for the store's staff (e.g. a tag that can be scanned by the store's cameras or RFID detectors). In some implementations, the store's network contacts the CPB to reveal the consumer's C-Rep to the store. In some implementations, the CPB contacts the consumer's mobile device using wide-area networks such as a mobile phone network. In some implementations, based on either explicit consent from the consumer, or his settings and certain parameters such as the consumer's location, the store's parameters, etc., the CPB reveals the consumer's C-Rep or denies the request.

The store policy may obstruct or prevent consumers with lower C-Rep from entering a section of the store (or the entire store), and/or may provide different levels of service depending upon the consumer's C-Rep. The store may also have policies to offer certain goods only to customers with a certain C-Rep. The store may have sections that require consumers to make payments for goods at advertised prices for goods offered in those sections.

In some implementations, once the Consumer's C-Rep is known to the store, it provides this information to the store's staff (either selectively, or openly). Depending upon store staff rules, one or more staff members may help the consumer in either selecting, or placing the physical goods into his possession. The staff member(s) may urge the Consumer to make a compelled payment. The store may or may not display suggested prices to the consumer before the consumer can get the goods into his possession.

If and when the consumer decides to make a compelled payment, it instructs the CPB to pay an amount to the store. The CPB pays a part of the requested amount to the store. When any C-Events related to that consumer and that store occur, the store independently informs the CPB of the C-Events, regardless of whether the consumer makes a compelled payment or not. In some implementations, the store later optionally sends reminders (over email or otherwise) to the consumer to make more compelled payments for the goods received in that store visit.

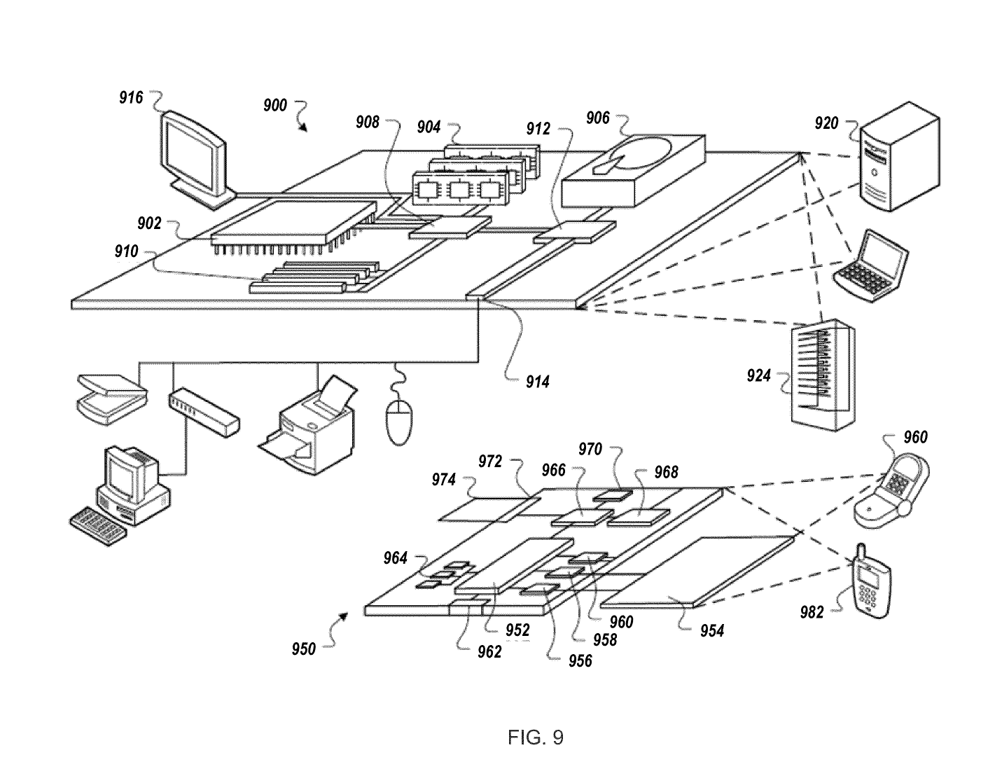

As shown in FIG. 9, an implementation of a network environment 900 for use in a reputation-building voluntary digital commerce system is shown and described. In brief overview, referring now to FIG. 9, a block diagram of an exemplary cloud computing environment 900 is shown and described. The cloud computing environment 900 may include one or more resource providers 902a, 902b, 902c (collectively, 902). Each resource provider 902 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 902 may be connected to any other resource provider 902 in the cloud computing environment 900. In some implementations, the resource providers 902 may be connected over a computer network 908. Each resource provider 902 may be connected to one or more computing device 904a, 904b, 904c (collectively, 904), over the computer network 908.

The cloud computing environment 900 may include a resource manager 906. The resource manager 906 may be connected to the resource providers 902 and the computing devices 904 over the computer network 908. In some implementations, the resource manager 906 may facilitate the provision of computing resources by one or more resource providers 902 to one or more computing devices 904. The resource manager 906 may receive a request for a computing resource from a particular computing device 904. The resource manager 906 may identify one or more resource providers 902 capable of providing the computing resource requested by the computing device 904. The resource manager 906 may select a resource provider 902 to provide the computing resource. The resource manager 906 may facilitate a connection between the resource provider 902 and a particular computing device 904. In some implementations, the resource manager 906 may establish a connection between a particular resource provider 902 and a particular computing device 904. In some implementations, the resource manager 906 may redirect a particular computing device 904 to a particular resource provider 902 with the requested computing resource.

FIG. 9 shows an example of a computing device 900 and a mobile computing device 950 that can be used to implement the techniques described in this disclosure. The computing device 900 is intended to represent various forms of digital computers, such as laptops, desktops, workstations, personal digital assistants, servers, blade servers, mainframes, and other appropriate computers. The mobile computing device 950 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 900 includes a processor 902, a memory 904, a storage device 906, a high-speed interface 908 connecting to the memory 904 and multiple high-speed expansion ports 910, and a low-speed interface 912 connecting to a low-speed expansion port 914 and the storage device 906. Each of the processor 902, the memory 904, the storage device 906, the high-speed interface 908, the high-speed expansion ports 910, and the low-speed interface 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as a display 916 coupled to the high-speed interface 908. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 904 stores information within the computing device 900. In some implementations, the memory 904 is a volatile memory unit or units. In some implementations, the memory 904 is a non-volatile memory unit or units. The memory 904 may also be another form of computer-readable medium, such as a magnetic or optical disk.

The storage device 906 is capable of providing mass storage for the computing device 900. In some implementations, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 902), perform one or more methods, such as those described above. The instructions can also be stored by one or more storage devices such as computer- or machine-readable mediums (for example, the memory 904, the storage device 906, or memory on the processor 902).

The high-speed interface 908 manages bandwidth-intensive operations for the computing device 900, while the low-speed interface 912 manages lower bandwidth-intensive operations. Such allocation of functions is an example only. In some implementations, the high-speed interface 908 is coupled to the memory 904, the display 916 (e.g., through a graphics processor or accelerator), and to the high-speed expansion ports 910, which may accept various expansion cards (not shown). In the implementation, the low-speed interface 912 is coupled to the storage device 906 and the low-speed expansion port 914. The low-speed expansion port 914, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. In addition, it may be implemented in a personal computer such as a laptop computer 922. It may also be implemented as part of a rack server system 924. Alternatively, components from the computing device 900 may be combined with other components in a mobile device (not shown), such as a mobile computing device 950. Each of such devices may contain one or more of the computing device 900 and the mobile computing device 950, and an entire system may be made up of multiple computing devices communicating with each other.

The mobile computing device 950 includes a processor 952, a memory 964, an input/output device such as a display 954, a communication interface 966, and a transceiver 968, among other components. The mobile computing device 950 may also be provided with a storage device, such as a micro-drive or other device, to provide additional storage. Each of the processor 952, the memory 964, the display 954, the communication interface 966, and the transceiver 968, are interconnected using various buses, and several of the components may be mounted on a common motherboard or in other manners as appropriate.

The processor 952 can execute instructions within the mobile computing device 950, including instructions stored in the memory 964. The processor 952 may be implemented as a chipset of chips that include separate and multiple analog and digital processors. The processor 952 may provide, for example, for coordination of the other components of the mobile computing device 950, such as control of user interfaces, applications run by the mobile computing device 950, and wireless communication by the mobile computing device 950.

The processor 952 may communicate with a user through a control interface 958 and a display interface 956 coupled to the display 954. The display 954 may be, for example, a TFT (Thin-Film-Transistor Liquid Crystal Display) display or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may provide communication with the processor 952, so as to enable near area communication of the mobile computing device 950 with other devices. The external interface 962 may provide, for example, for wired communication in some implementations, or for wireless communication in other implementations, and multiple interfaces may also be used.

The memory 964 stores information within the mobile computing device 950. The memory 964 can be implemented as one or more of a computer-readable medium or media, a volatile memory unit or units, or a non-volatile memory unit or units. An expansion memory 974 may also be provided and connected to the mobile computing device 950 through an expansion interface 972, which may include, for example, a SIMM (Single In Line Memory Module) card interface. The expansion memory 974 may provide extra storage space for the mobile computing device 950, or may also store applications or other information for the mobile computing device 950. Specifically, the expansion memory 974 may include instructions to carry out or supplement the processes described above, and may include secure information also. Thus, for example, the expansion memory 974 may be provide as a security module for the mobile computing device 950, and may be programmed with instructions that permit secure use of the mobile computing device 950. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 952), perform one or more methods, such as those described above. The instructions can also be stored by one or more storage devices, such as one or more computer- or machine-readable mediums (for example, the memory 964, the expansion memory 974, or memory on the processor 952). In some implementations, the instructions can be received in a propagated signal, for example, over the transceiver 968 or the external interface 962.

The mobile computing device 950 may communicate wirelessly through the communication interface 966, which may include digital signal processing circuitry where necessary. The communication interface 966 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 968 using a radio-frequency. In addition, short-range communication may occur, such as using a Bluetooth®, Wi-Fi™, or other such transceiver (not shown). In addition, a GPS (Global Positioning System) receiver module 970 may provide additional navigation- and location-related wireless data to the mobile computing device 950, which may be used as appropriate by applications running on the mobile computing device 950.

The mobile computing device 950 may also communicate audibly using an audio codec 960, which may receive spoken information from a user and convert it to usable digital information. The audio codec 960 may likewise generate audible sound for a user, such as through a speaker, e.g., in a handset of the mobile computing device 950. Such sound may include sound from voice telephone calls, may include recorded sound (e.g., voice messages, music files, etc.) and may also include sound generated by applications operating on the mobile computing device 950.

The mobile computing device 950 may be implemented in a number of different forms, as shown in the figure. For example, it may be implemented as a cellular telephone 980. It may also be implemented as part of a smart-phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, a system and method for a reputation-building voluntary digital commerce are provided. Having described certain implementations of methods and apparatus for supporting reputation-building voluntary digital commerce, it will now become apparent to one of skill in the art that other implementations incorporating the concepts of the disclosure may be used. Therefore, the disclosure should not be limited to certain implementations, but rather should be limited only by the spirit and scope of the following claims.

Throughout the description, where apparatus and systems are described as having, including, or comprising specific components, or where processes and methods are described as having, including, or comprising specific steps, it is contemplated that, additionally, there are apparatus, and systems of the present invention that consist essentially of, or consist of, the recited components, and that there are processes and methods according to the present invention that consist essentially of, or consist of, the recited processing steps.

It should be understood that the order of steps or order for performing certain action is immaterial so long as the invention remains operable. Moreover, two or more steps or actions may be conducted simultaneously.

What is claimed:

1. A method comprising:
receiving, from a consumer, via a network, a request for information regarding wares available from a merchant;
identifying, by a processor of a computing device, from the request, a consumer identification;
obtaining, from a compelled payment broker, a consumer reputation score associated with the consumer identification, wherein the consumer reputation score is based in part upon one or more payments made by the consumer in relation to one or more prior wares provided to the consumer by one or more merchants;
identifying, by the processor, one or more wares;
providing, to the consumer at a second computing device, information regarding the one or more wares; and
at least one of a) identifying the one or more wares and b) providing information regarding the one or more wares is based in part upon the consumer reputation score.

2. The method of claim 1, wherein providing information regarding the one or more wares further comprises:
providing, for review by the consumer at the second computing device, an offer to convey one or more wares to the consumer;
receiving, from the consumer at the second computing device, a request to convey one or more wares to the consumer; and
providing, to the consumer at the second computing device, one or more wares.

3. The method of claim 1, wherein providing information regarding the one or more wares further comprises providing, to the consumer at the second computing device, one or more wares.

4. The method of claim 1, wherein:
each ware of the one or more wares is associated with one or more aspects, wherein the one or more aspects comprise at least one of a currency and a quality; and
identifying the one or more wares comprises:
identifying at least one of a currency level and a quality level associated with the consumer reputation score; and
selecting each ware of the one or more wares based in part upon at least one of the currency and the quality.

5. The method of claim 1, wherein identifying the one or more wares comprises selecting a total number of the one or more wares based at least in part upon the consumer reputation score.

6. The method of claim 1, wherein providing information regarding the one or more wares comprises:
identifying a service level associated with the consumer reputation score; and
transmitting the information regarding the one or more wares at a speed relative to the service level.

7. The method of claim 1, wherein providing information regarding the one or more wares comprising identifying at least one of a graphical layout and an advertisement strategy based upon the consumer reputation score.

8. The method of claim 1, further comprising:
receiving, responsive to the request for payment, remittance associated with the one or more wares; and
updating, via the compelled payment broker, the consumer reputation score.

9. The method of claim 8, wherein the consumer reputation score is based in part upon a frequency of payment relative to a number of times the merchant provides one or more wares to the consumer.

10. The method of claim 8, wherein the consumer reputation score is based in part upon a difference between a requested payment value and an actual payment value.

11. The method of claim 8, wherein the consumer reputation score is based in part upon one or more other wares conveyed by one or more other merchants.

12. The method of claim 8, further comprising, prior to receiving remittance, providing, to the consumer, a reminder regarding the request for payment, wherein the consumer reputation score is based in part upon at least one of an expedience of payment and a number of reminders issued prior to payment.

13. The method of claim 1, further comprising, prior to providing the request for payment:
receiving, from the consumer, a request for at least one ware of the one or more wares; and
providing, to the consumer, the at least one ware.

14. A system comprising:
a processor; and
a memory having instructions stored thereon, wherein the instructions, when executed, cause the processor to:
receive, from a consumer, via a network, a request for information regarding wares available from a merchant;
identify, from the request, a consumer identification;
obtain, from a compelled payment broker, a consumer reputation score associated with the consumer identification, wherein the consumer reputation score is based in part upon one or more payments made by the consumer in relation to one or more prior wares provided to the consumer by the merchant;
identify one or more wares;
provide, to the consumer at a second computing device, information regarding the one or more wares; and
wherein at least one of a) identifying the one or more wares and b) providing information regarding the one or more wares is based in part upon the consumer reputation score.

15. The system of claim 14, wherein providing information regarding the one or more wares further comprises:
providing, for review by the consumer at the second computing device, an offer to convey one or more wares to the consumer;
receiving, from the consumer at the second computing device, a request to convey one or more wares to the consumer; and
providing, to the consumer at the second computing device, one or more wares.

16. The system of claim 14, wherein providing information regarding the one or more wares further comprises providing, to the consumer at the second computing device, one or more wares.

17. The system of claim 14, wherein obtaining the consumer reputation score comprises providing, to the compelled payment broker, context information regarding the request for information.

18. The system of claim 14, wherein providing information regarding the one or more wares comprises embedding, within the information regarding the one or more wares, a tracking item associated with the compelled payment broker.

19. The system of claim 14, wherein the tracking item comprises a cookie.

20. The system of claim 14, wherein the tracking item is invisible to the consumer upon reviewing the information regarding the one or more wares.
